(19) United States
(12) Patent Application Publication
(10) Pub. No.: US 2025/0037293 A1
(43) Pub. Date: Jan. 30, 2025

(54) IMAGE ANALYSIS SYSTEM, IMAGE ANALYSIS METHOD, AND NON-TRANSITORY COMPUTER-READABLE MEDIUM

(71) Applicant: NEC Corporation, Minato-ku, Tokyo (JP)

(72) Inventors: Yaeko Yonezawa, Tokyo (JP); Tomokazu Kaneko, Tokyo (JP); Ryosuke Sakai, Tokyo (JP)

(73) Assignee: NEC Corporation, Minato-ku, Tokyo (JP)

(21) Appl. No.: 18/697,039

(22) PCT Filed: Oct. 12, 2021
(86) PCT No.: PCT/JP2021/037738

§ 371 Date: Mar. 29, 2024

(51) Int. Cl. G06T 7/60; G06V 10/75

(52) U.S. Cl. CPC G06T 7/60; G06V 10/751; G06V 2201/09

(57) ABSTRACT

An image analysis system (1) includes a reference area detection unit (110) and a management unit determination unit (120). The reference area detection unit (110) can detect a reference area within a product from an image by processing the image of the product. The management unit determination unit (120) determines a management unit of the product by using a ratio of a size of the reference area with respect to an image area of the product.

### TECHNICAL FIELD

The present invention relates to a technique for identifying a product by using an image.

### BACKGROUND ART

A technique for identifying a product by analyzing an image acquired by photographing an external appearance of the product has been utilized in a store. Herein, there is a product sold in various sizes (net amounts) among products handled in a store. Regarding a product as described above, it is necessary to manage the product for each size (net amount) in a store.

One example of a technique for identifying a same product of a different size is, for example, disclosed in Patent Document 1 described below. Patent Document 1 discloses a technique in which a real size of a subject of a query image is estimated by using an actual size ratio of the query image per pixel, and a size of an area of the subject in the query image, and a size of the subject in the query image is estimated based on a real size of a subject included in the same cluster image as that of the subject, among the clusters included in a size difference list generated in advance.

### RELATED DOCUMENT

### Patent Document

Patent Document 1: Japanese Patent Application Publication No. 2020-095408

### SUMMARY OF INVENTION

### Technical Problem

In the technique in Patent Document 1, an actual size ratio of an image per pixel may vary depending on a position (relative position of a camera with respect to a subject) when the image is photographed, or camera settings. Therefore, a real size of a product captured in an image cannot be stably estimated, unless an accurate actual size ratio is acquired for each image to be processed.

The present invention has been made in view of the above problem. One of objects of the present invention is to provide a technique for stably identifying a size (net amount) and the like of a product, based on an image.

### Solution to Problem

An image analysis system according to the present disclosure includes: a reference area detection unit that detects a reference area within a product from an image by processing the image of the product; and a management unit determination unit that determines a management unit of the product by using a ratio of a size of the reference area with respect to an image area of the product.

An image analysis method according to the present disclosure includes,
by a computer:
detecting a reference area within a product from an image by processing the image of the product; and
determining a management unit of the product by using a ratio of a size of the reference area with respect to an image area of the product.

A program according to the present disclosure causes a computer to function as:
a reference area detection unit that detects a reference area within a product from an image by processing the image of the product; and
a management unit determination unit that determines a management unit of the product by using a ratio of a size of the reference area with respect to an image area of the product.

### Advantageous Effects of Invention

The present invention enables to stably identify a size (net amount) of a product, based on an image.

### BRIEF DESCRIPTION OF DRAWINGS

FIG. 1 It is a diagram illustrating a functional configuration example of an image analysis system according to a first example embodiment.

FIG. 2 It is a block diagram illustrating a hardware configuration of an information processing apparatus including each functional configuration unit of the image analysis system.

FIG. 3 It is a flowchart illustrating a flow of processing to be performed by the image analysis system according to the first example embodiment.

FIG. 4 It is a diagram used for describing one example of a specific operation of a management unit determination unit.

FIG. 5 It is a diagram used for describing another example of a specific operation of the management unit determination unit.

FIG. 6 It is a diagram illustrating a functional configuration example of an image analysis system according to a second example embodiment.

FIG. 7 It is a diagram illustrating one example of dictionary data to be used in the image analysis system according to the second example embodiment.

FIG. 8 It is a flowchart illustrating one example of processing to be performed by the image analysis system according to the second example embodiment.

FIG. 9 It is a flowchart illustrating one example of processing to be performed by the image analysis system according to the second example embodiment.

FIG. 10 It is a diagram illustrating one example of information output by a product determination unit.

FIG. 11 It is a flowchart illustrating another example of processing to be performed by the image analysis system according to the second example embodiment.

### DESCRIPTION OF EMBODIMENTS

Hereinafter, example embodiments according to the present invention are described by using the drawings. Note that, in all drawings, a similar constituent element is indicated by a similar reference sign, and description thereof will not be repeated as appropriate. Further, in each block diagram, each block does not represent a configuration of a hardware unit, but represents a configuration of a functional unit, unless otherwise specifically mentioned. Further, a direction of an arrow in the drawings is to simply make it easy to understand a flow of information. Unless otherwise specifically mentioned, the direction of the arrow in the drawings does not limit a direction of communication (one-directional communication/bi-directional communication).

### First Example Embodiment

### Functional Configuration Example

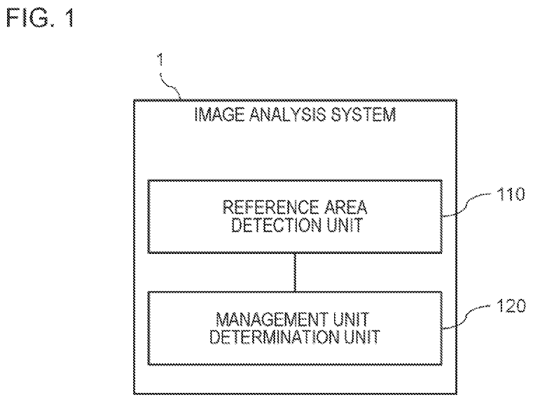

FIG. 1 is a diagram illustrating a functional configuration example of an image analysis system according to a first example embodiment. An image analysis system 1 illustrated in FIG. 1 includes a reference area detection unit 110 and a management unit determination unit 120. The reference area detection unit 110 acquires, as an image to be processed, an image in which a product is captured, and detects a reference area within the product captured in the image by processing the image. The management unit determination unit 120 determines a management unit of the product by using a ratio of a size of the reference area with respect to an image area associated with the product.

Herein, a “management unit” in the present disclosure means a variation of a product whose type (content) is the same. For example, it is assumed that regarding a certain PET bottle beverage, a product contained in a 350 ml container, and a product contained in a 500 ml container are handled in a store. In this case, variations related to a net amount of the PET bottle beverage, such as “350 ml” and “500 ml”, are each equivalent to a “management unit” in the present disclosure. Note that, the management unit is not limited to a variation of a net amount. For example, variations of a product size that does not indicate a specific net amount, such as “large (L)”, “medium (M)”, and “small (S)”, are also included in the “management units” in the present disclosure.

Further, a “reference area” in the present disclosure is utilized as information for determining a “manage unit” from an image. A “reference area” in the present disclosure is an any area including an external appearance feature utilizable as a reference for determining a management unit in a product of a same type. Note that, as an external appearance feature included in a reference area, a feature in which a size hardly changes, even when the above-described management unit is different, is preferable. A specific example of an external appearance feature capable of being included in a reference area is not specifically limited, but a cap portion of a product, a sealing portion of a product package, a logo of a company or a brand, a product display mark, an indication of special notes, and the like are exemplified. A cap portion of a product is a component provided at a mouth portion of a container containing a product, and includes, for example, a cap of a PET bottle, a measurement cap or a measurement nozzle of a liquid detergent container, and the like. A sealing portion of a product package is, for example, a portion to which sealer processing is applied in order to seal a bag container (package) for accommodating snack food, and the like. A logo of a company or a brand is a logo designed for a company manufacturing a product, or a brand of the product (e.g., a product name). A product display mark is a specific mark defined for each certain category, and including, for example, a Japanese agricultural standard (JAS) mark, a fair mark, a certification mark for a regional specialty product, a safety & quality (SQ) mark, a certification mark, a certification mark by the Japan frozen noodles association (RMK), a mark for foods for specified health use, a mark for foods with functional claims, a self-medication logomark, a pharmaceuticals mark, a recycle mark, and the like. Further, an indication of special notes is a certain indication (e.g., an indication “Danger! Do not mix!” for a chlorine-based detergent product) calling for attention when a product is handled. The reference area detection unit 110 is configured in such a way that an area at least partially including at least any one of these marks is detected as a “reference area” from an image area of a product.

### <Hardware Configuration of Image Analysis System 1>

Each functional configuration unit of the image analysis system 1 may be achieved by hardware (example: a hard-wired electronic circuit, and the like) that achieves each functional configuration unit, or may be achieved by combination of hardware and software (example: combination of an electronic circuit, and a program that controls the electronic circuit, and the like). Hereinafter, a case in which each functional configuration unit of the image analysis system 1 is achieved by combination of hardware and software in one information processing apparatus is further described.

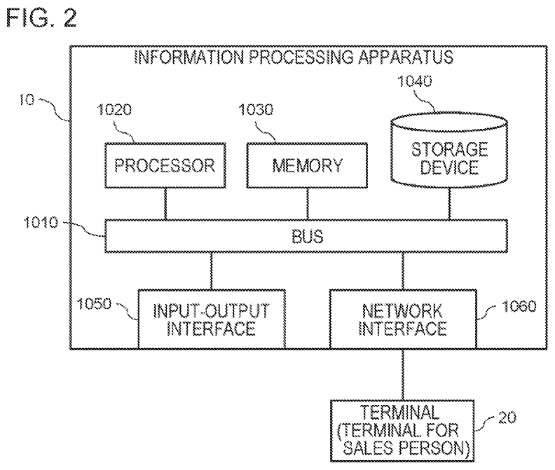

FIG. 2 is a block diagram illustrating a hardware configuration of an information processing apparatus 10 including each functional configuration unit of the image analysis system 1. The information processing apparatus 10 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module that achieves each function of the image analysis system 1 to be described in the present specification. Each function of the image analysis system 1 to be described in the present specification is achieved by causing the processor 1020 to read the program module in the memory 1030 and execute the program module.

The input/output interface 1050 is an interface for connecting the information processing apparatus 10 to peripheral equipment. An input apparatus such as a keyboard, a mouse, and a touch panel, and an output apparatus such as a display and a speaker can be connected to the input/output interface 1050.

The network interface 1060 is an interface for connecting the information processing apparatus 10 to a network. The network is, for example, a local area network (LAN) or a wide area network (WAN). A method of connecting to the network via the network interface 1060 may be wireless connection, or may be wired connection. As one example, the information processing apparatus 10 can communicate, via the network interface 1060, with a terminal 20 carried by a sales person, another external storage apparatus, or the like being connected to the network.

Note that, the hardware configuration illustrated in FIG. 2 is merely one example. A hardware configuration of the image analysis system 1 according to the present disclosure is not limited to the example in FIG. 2. For example, various functions of the image analysis system 1 according to the present disclosure may be incorporated in a single information processing apparatus, or may be incorporated in a plurality of information processing apparatus in a distributed manner. Further, in the example in FIG. 2, the information processing apparatus 10 including each function of the image analysis system 1 is illustrated as an apparatus different from the terminal 20 used by a sales person, but all or some of the functions of the image analysis system 1 may be included in the terminal 20 used by a sales person.

### <Flow of Processing>

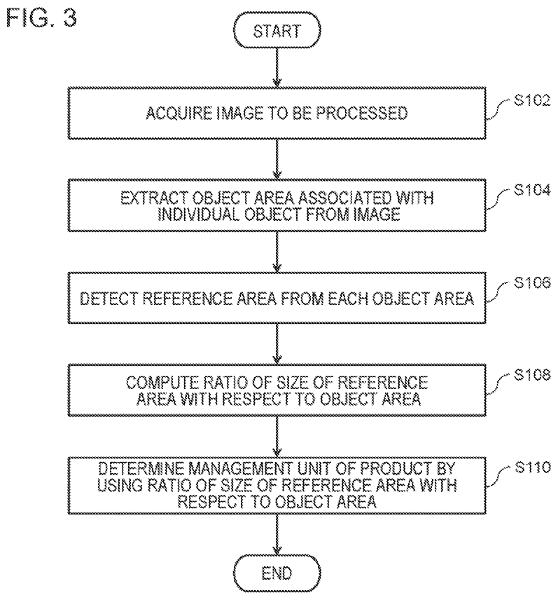

FIG. 3 is a flowchart illustrating a flow of processing to be performed by the image analysis system 1 according to the first example embodiment.

First, the reference area detection unit 110 acquires, as an image to be processed, an image of a product photographed by an unillustrated image capturing apparatus (S102). An image of a product is photographed, for example, by using a camera loaded in a terminal (e.g., the terminal 20 illustrated in FIG. 2) carried by a sales person. A sales person photographs, for example, a place (such as a product shelf) where a product is displayed by using a camera function of a terminal. The reference area detection unit 110 can acquire an image of a product from the terminal, or from an unillustrated server apparatus that collects and accumulates an image generated by the terminal.

Then, the reference area detection unit 110 extracts an image area associated with an individual object from the acquired image (S104). In the following description, an image area associated with an individual object is also described as an “object area”. The reference area detection unit 110 can recognize an individual object (object area) within an image by using, for example, an object recognition model (not illustrated) learned by a machine learning algorithm such as Deep Learning. As one example, the object recognition model is stored in advance in the storage device 1040 of the information processing apparatus 10 in FIG. 2. As another example, the object recognition model may be stored in an external apparatus (not illustrated) communicably connected to the information processing apparatus 10 in FIG. 2 via the network interface 1060.

Then, the reference area detection unit 110 detects a reference area from each of the object areas extracted from the image (S106). As one example, the reference area detection unit 110 uses an unillustrated learning model made by learning in such a way that each of reference areas of various types as described in the foregoing is recognized from an input image. The learning model may be, for example, stored in advance in the storage device 1040 of the information processing apparatus 10 in FIG. 2, or may be stored in an external apparatus (not illustrated) communicably connected to the information processing apparatus 10 in FIG. 2 via the network interface 1060. The reference area detection unit 110 can acquire, from a learning model, information indicating a reference area in an object area (image area) given as an input by giving, to the learning model, each object area extracted by processing of S104, as an input.

The management unit determination unit 120 computes a ratio of a size of the object area extracted by processing of S104 with respect to the reference area detected by processing of S106 regarding the object area (S108). The management unit determination unit 120 may acquire, for example, each of a size (pixel number) of the object area in a height direction, and a size (pixel number) of the reference area detected regarding the object area in the height direction, and compute a ratio between the sizes. Then, the management unit determination unit 120 determines a management unit of the product by using the ratio of the size, being computed by processing of S108, of the reference area with respect to the object area (S110). Hereinafter, a specific operation of the management unit determination unit 120 is described by using a drawing.

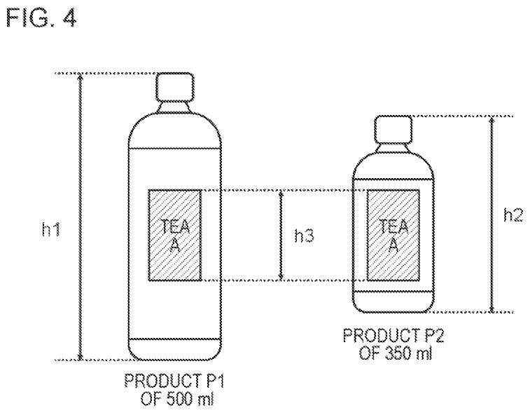

FIG. 4 is a diagram used for describing one example of a specific operation of the management unit determination unit 120. FIG. 4 illustrates a case in which an area (an area indicated by a hatched line in FIG. 4) in which a logo of a product brand is drawn on a package of a product of a PET bottle beverage called “tea A” is detected as a “reference area”. Herein, in the example in FIG. 4, it is assumed that a product called “tea A” is sold in two management units of “500 ml” and “350 ml”, and a size of a logo of a product brand remains unchanged in a product package for each management unit.

Therefore, as illustrated in FIG. 4, the sizes of a logo area (specifically, a reference area) of the product brand are the same in a product P1 of 500 ml, and a product P2 of 350 ml. In particular, in the example in FIG. 4, both of sizes of the logo areas of the product brand in the height direction are “h3”. Meanwhile, since management units are different between the product P1 of 500 ml, and the product P2 of 350 ml, sizes of the entireties of the products (specifically, an object area in an image) are different from each other. In particular, a size of the entirety of the product in the height direction is “h1” in the product P1 of 500 ml, and “h2(<h1)” in the product P2 of 350 ml. Note that, sizes of “h1”, “h2”, and “h3” can be acquired as a numerical value (e.g., a pixel number of each area in the height direction) based on, for example, a pixel number in an image to be processed.

The management unit determination unit 120 computes a ratio of a size of a logo area of a product brand (specifically, a size of a reference area in an image) with respect to a size of the entirety of a product (specifically, a size of an object area in an image). For example, regarding an object area associated with the product P1 of 500 ml, the management unit determination unit 120 can compute a numerical value of “h3/h1”, as a value of a ratio of a size of a reference area occupying the object area in the height direction. Further, regarding an object area associated with the product P2 of 350 ml, the management unit determination unit 120 can compute a numerical value of “h3/h2”, as a value of a ratio of a size of a reference area occupying the object area in the height direction. In this case, due to establishing a relationship of “h2<h1”, the value of the ratio computed regarding the product P1 of 500 ml becomes significantly small, as compared with the value of the ratio computed regarding the product P2 of 350 ml.

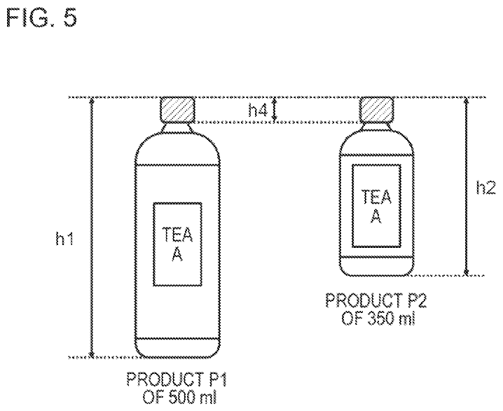

FIG. 5 is a diagram used for describing another example of a specific operation of the management unit determination unit 120. The example in FIG. 5 illustrates, regarding consumption of a PET bottle beverage called “tea A”, a case in which an area (an area indicated by a hatched line in FIG. 5) of a cap portion of a PET bottle is detected as a “reference area”. Herein, a cap of a PET bottle is basically manufactured with a similar size in accordance with a common standard. Therefore, an area of a cap portion of a PET bottle can be utilized as a reference area, similarly to the logo area of the product brand in the example in FIG. 4. In other words, also in the example in FIG. 5, the management unit determination unit 120 performs processing similar to the processing described with reference to FIG. 4. Specifically, the management unit determination unit 120 can compute each of a numerical value of “h4/h1”, as a value of a ratio of a size of the product P1 of 500 ml in the height direction, and a numerical value of “h4/h2”, as a value of a ratio of a size of the product P2 of 350 ml in the height direction. Also, in this case, since a relationship of “h2<h1” is established, the value of the ratio computed regarding the product P1 of 500 ml becomes significantly small, as compared with the value of the ratio computed regarding the product P2 of 350 ml.

In this way, a ratio of a size occupied by a reference area with respect to an object area becomes useful information for determining a management unit of a product. For example, the management unit determination unit 120 can determine a management unit of an identified product by using a ratio of a size of a reference area with respect to an object area in combination with an identification result of the product based on image feature information of the object area. In this case, an identification result of a product associated with each object area is supplied from, for example, another processing unit (not illustrated) that performs product identification processing. The management unit determination unit 120 can determine a management unit of a product by comparing a ratio of a size computed by processing of S108 with a ratio of a size acquired similarly from information (example: a front view image of a product, or the like) indicating an external appearance feature registered in advance for each management unit regarding the identified product. Further, there is a case in which a management unit can be determined by using a ratio of a size of a reference area with respect to an object area acquired by processing as described above, without an identification result of a product. For example, regarding a PET bottle beverage, a size of a product for each management unit (net amount) does not differ so much depending on a manufacturer or a type of a product. Further, a size of a cap of a PET bottle beverage also does not differ so much depending on a manufacturer or a type of a product. Therefore, when an area associated with a cap of a PET bottle is detected as a reference area, a ratio of a size of the reference area with respect to an object area may become by itself information indicating a management unit (such as a 350 ml container, or a 500 ml container). Thus, in a case as described above, the management unit determination unit 120 can determine a management unit, based on a ratio of a size of a reference area with respect to an object area, even when a product in the object area including the reference area is in an unidentified state.

### Example of Advantageous Effect

There is also a possibility that distortion occurs in a subject (product) within an image due to a positional relationship between a camera and the subject (product) at the time when an image to be processed is photographed, a characteristic of hardware of the camera, or the like. For example, when photographing is performed with a camera looking down on a subject (product), the subject (product) is photographed in a state that the subject narrows towards the bottom of an image. When an actual size ratio per pixel is adopted, as exemplified in the technique disclosed in Patent Document 1, an error occurs between a real size of a subject, and a size of the subject acquired from an image due to the distortion. Then, a management unit (such as a size) of a product may not be accurately determined from an image. In contrast, in the image analysis system 1 according to the present example embodiment, a ratio of a size is computed for an area detected from an image. Computing a ratio as described above offsets an influence due to a distorted subject within an image. Consequently, it becomes possible to stably determine a management unit (such as a size or a net amount) of a product even from an image in which distortion occurs in a product as a subject.

### Second Example Embodiment

A present example embodiment includes a configuration similar to that of the first example embodiment except for a point described below.

### Functional Configuration Example

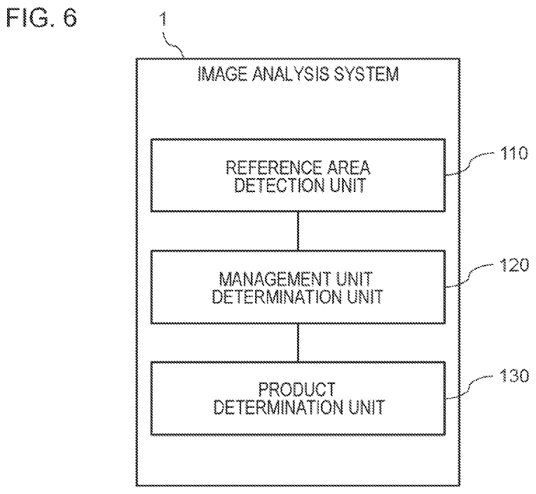

FIG. 6 is a diagram illustrating a functional configuration example of an image analysis system according to a second example embodiment. An image analysis system 1 illustrated in FIG. 6 includes a product determination unit 130, in addition to a reference area detection unit 110 and a management unit determination unit 120 described in the first example embodiment.

The product determination unit 130 determines a product captured in an image, based on image feature information acquired from the image of the product acquired as a processing target, and dictionary data including information (hereinafter, also described as “product external appearance information”) indicating an external appearance feature of each product. The product determination unit 130 compares image feature information acquired from an image of a product with product external appearance information of each product included in dictionary data, and computes a matching degree of an external appearance feature (matching degree of a keypoint) between a product captured in an image, and each product registered in dictionary data. Then, the product determination unit 130 determines, as a candidate of the product captured in the image acquired as a processing target, a product having an external appearance feature having a matching degree being equal to or more than a predetermined reference.

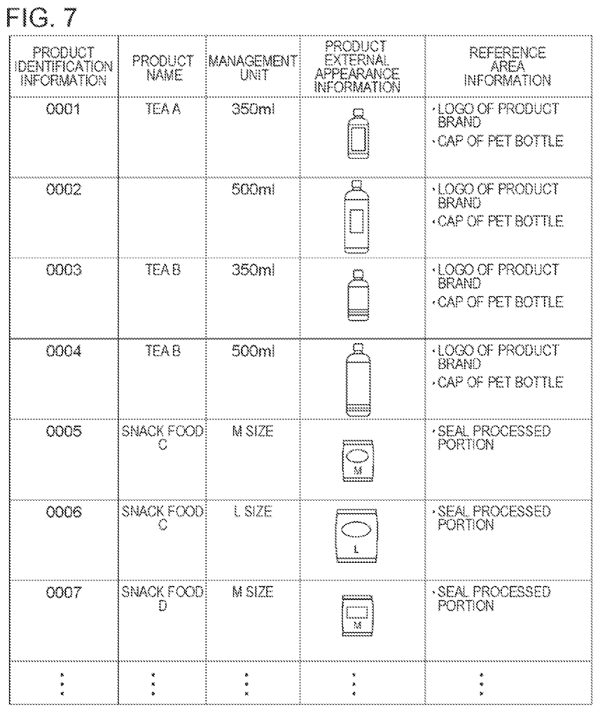

FIG. 7 is a diagram illustrating one example of dictionary data to be used in the image analysis system 1 according to the second example embodiment. Various pieces of information associated with a product are registered in the dictionary data for each product (product having a management unit). For example, the dictionary data illustrated in FIG. 7 include, for each product, product identification information, a product name, a management unit, product external appearance information, and a reference area type, as various pieces of information associated with the product. Product external appearance information is any information indicating an external appearance of a product. For example, product external appearance information may be a sample image acquired by photographing a certain product from a front side, may be image feature information generated based on a sample image as described above, or may be combination of these. Reference area information is information for identifying a type of a reference area from which the product is to be detected. The dictionary data are stored, for example, in a storage device 1040 or the like of the information processing apparatus 10 in FIG. 2.

Herein, as a result of processing by the product determination unit 130, there is also a case in which a plurality of products are determined as a candidate, as a product having an external appearance feature having a matching degree being equal to or more than a predetermined reference. For example, a case in which a product captured in an image is a PET bottle beverage (for convenience, referred to as “tea A”), and “tea A of a 350 ml container” and “tea A of a 500 ml container” are handled in a store is considered. These “tea A of a 350 ml container” and “tea A of a 500 ml container” are same products from a point of view of a type of a product, but are different products from a point of view of a management unit in a store. Therefore, information regarding each of these two products is registered in the dictionary data. Herein, when a type of a product is the same, an external appearance feature (package design) of each of the products is basically similar to each other. Therefore, when the product determination unit 130 determines a product, based on an image, there is also a possibility that each of “tea A of a 350 ml container” and “tea A of a 500 ml container” is determined as a “product having an external appearance feature having a matching degree being equal to or more than a reference value”.

In the image analysis system 1 according to the present example embodiment, as one example, when a plurality of products being the same except for a management unit are determined as described above, processing (processing as described in the first example embodiment) by the reference area detection unit 110 and the management unit determination unit 120 is performed. Then, the image analysis system 1 according to the present example embodiment uniquely determines a product captured in an image to be processed, based on a management target determined by the management unit determination unit 120.

### <Flow of Processing>

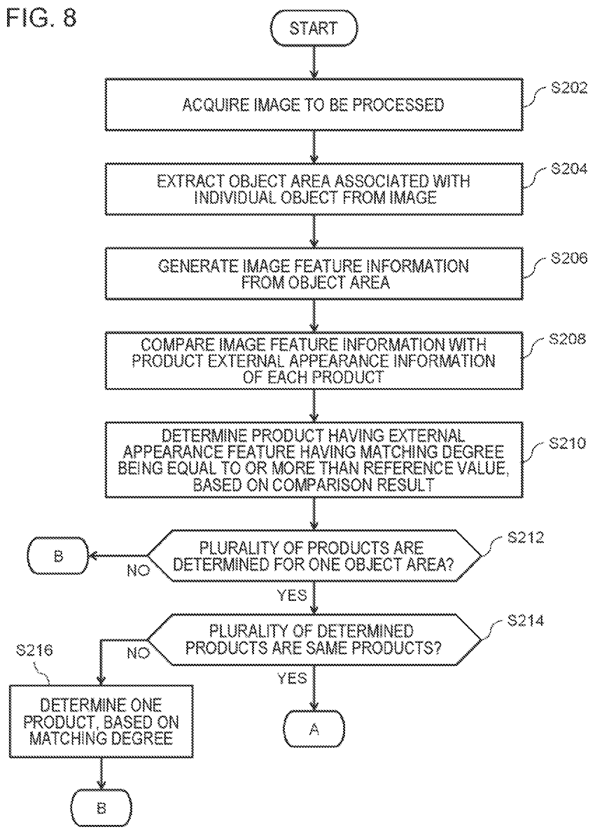

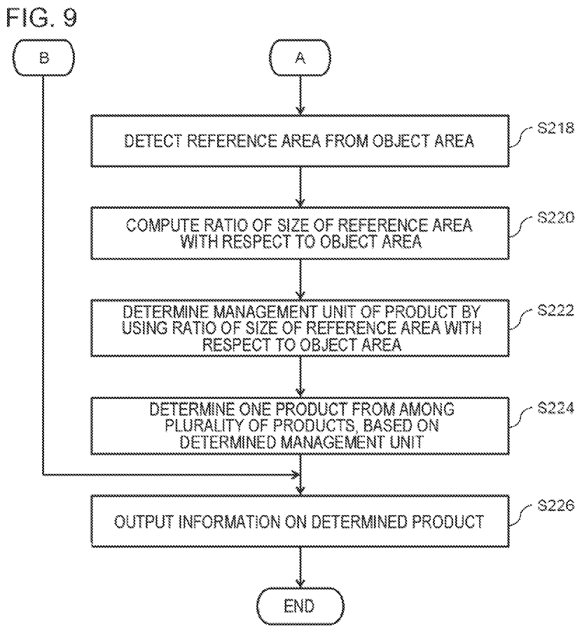

FIGS. 8 and 9 are flowcharts illustrating one example of processing to be performed by the image analysis system 1 according to the second example embodiment.

First, the product determination unit 130 acquires, as an image for processing handling, an image of a product photographed by an unillustrated image capturing apparatus (S202). An image of a product is photographed, for example, by using a camera loaded in a terminal (e.g., the terminal 20 illustrated in FIG. 2) carried by a sales person. A sales person photographs, for example, a place (such as a product shelf) where a product is displayed by using a camera function of a terminal. The product determination unit 130 can acquire an image of a product from the terminal, or from an unillustrated server apparatus that collects and accumulates an image generated by the terminal.

Then, the product determination unit 130 extracts an image area (object area) associated with an individual object from the acquired image (S204). The product determination unit 130 can recognize an individual object (object area) within an image by using, for example, an object recognition model (not illustrated) learned by a machine learning algorithm such as Deep Learning. As one example, the object recognition model is stored in advance in the storage device 1040 of the information processing apparatus 10 in FIG. 2. As another example, the object recognition model may be stored in an external apparatus (not illustrated) communicably connected to the information processing apparatus 10 in FIG. 2 via a network interface 1060.

Then, the product determination unit 130 generates image feature information for each of the extracted object areas (S206). The product determination unit 130 can generate various pieces of image feature information from each object area by using a known method.

Then, the product determination unit 130 compares image feature information generated for each object area with product external appearance information of each product included in dictionary data (S208). The product determination unit 130 determines, based on a comparison result, a product having an external appearance feature having a matching degree to image feature information acquired from a certain object area being equal to or more than a reference value from among products registered in the dictionary data (S210).

Then, the product determination unit 130 determines whether a plurality of products are determined as a result of processing of S208 (S212). Herein, when only one certain product is determined as a product having an external appearance feature having a matching degree to image feature information acquired from an object area being equal to or more than a reference value (S212:NO), the product determination unit 130 outputs information on the determined product (S226). On the other hand, when a plurality of products are determined as a product having an external appearance feature having a matching degree to image feature information acquired from an object area being equal to or more than the reference value (S212:YES), the product determination unit 130 further determines whether the plurality of determined products are same products (S214). Note that, in processing of S214, the product determination unit 130 determines whether the plurality of determined products are the “same products”, based on a “type (content) of a product”. In other words, the product determination unit 130 does not consider difference of a “management target” regarding a plurality of determined products. For example, two products (products of different sizes) in which a content of a product is the same but a net amount is different are determined to be the “same products” by processing of S214.

When the plurality of determined products are not the same products (S214:NO), the product determination unit 130 determines one product, for example, based on a matching degree computed for each of the products (S216). As one example, the product determination unit 130 can select one product in which a matching degree is highest from among a plurality of determined products, and acquire the selected one product, as a final determination result. Then, the product determination unit 130 outputs information on the determined product (S226). On the other hand, when the plurality of determined products are the same products, specifically, when the plurality of determined products are the same products except for a management unit (S214:YES), the product determination unit 130 requests the reference area detection unit 110 and the management unit determination unit 120 to perform processing.

In response to the request from the product determination unit 130, the reference area detection unit 110 detects a reference area for each of the object areas extracted by processing of S204 (S218). Herein, as illustrated in FIG. 7, for example, a type of a reference area to be detected may be defined for each product. The reference area detection unit 110 can determine information (reference area information) indicating a type of a reference area being associated with a determination result (product identification information) of a product, based on a determination result (product identification information) of the product made by the product determination unit 130, and dictionary data as illustrated in FIG. 7. Then, as described in the first example embodiment, the reference area detection unit 110 detects a reference area associated with the determined type from the object area.

When a reference area is detected by the reference area detection unit 110, the management unit determination unit 120 computes a ratio of a size of an object area extracted by processing of S204 with respect to a reference area detected by processing of S218 regarding the object area (S220). The processing is similar to the processing of S108 in the flowchart in FIG. 3. Then, the management unit determination unit 120 determines a management unit of a product present in an object area by using a ratio of a size of a reference area with respect to the object area being computed by processing of S220 (S222).

The product determination unit 130 finally determines, based on a determination result regarding a management unit by the management unit determination unit 120, one product from among a plurality of products being the same except for a management unit (S224). Then, the product determination unit 130 outputs information on the finally determined one product (S226).

The above-described pieces of processing of S218 to S226 are described by a more specific example. For example, it is assumed that the product determination unit 130 compares image feature information of a certain object area with product external appearance information of each product within dictionary data, and determines two products of “tea A of a 350 ml container” and “tea A of a 500 ml container”, as products having a matching degree being equal to or more than a reference. These two products are “tea A”, being the same regarding a type of a product, but are different regarding a management unit, specifically, one being “350 ml” and the other being “500 ml”.

In this case, the product determination unit 130 issues a processing execution request to the reference area detection unit 110 and the management unit determination unit 120. In response to the request from the product determination unit 130, the reference area detection unit 110 detects a reference area from an object area from which a product determination result as described above is acquired. The reference area detection unit 110 can determine, for example, at least one of “a logo of a product brand” and “a cap of a PET bottle”, as a type of a reference area associated with a determination result (tea A) by the product determination unit 130, based on information as illustrated in FIG. 7. Then, the reference area detection unit 110 detects, as a reference area, at least one of an area associated with “a logo of a product brand”, and an area associated with “a cap of a PET bottle” from the object area.

Then, the management unit determination unit 120 computes a ratio of a size of a reference area detected by the reference area detection unit 110 with respect to an object area. Then, the product determination unit 130 determines a management unit of the product present in the object area by using a ratio of a size of the reference area with respect to the object area. Herein, a ratio of a size of a reference area (area associated with a cap of a PET bottle, or a logo of a product brand) with respect to an object area can be computed in advance, for example, based on a numerical value actually measured for each product (product having a management unit). When information as described above is associated in advance with product identification information in FIG. 7, for example, the management unit determination unit 120 can determine a management unit, based on similarity between an actual measurement value being associated with a product determined by the product determination unit 130, and a value of a ratio computed by the management unit determination unit 120. For example, regarding “tea A of a 350 ml container” and “tea A of a 500 ml container”, it is assumed that an actual measurement result of “2:1” and “4:1” is acquired as a ratio of a size of a logo (reference area) of a product brand with respect to the entire area (object area) of each of the product containers in a height direction, and information related to these actual measurement results is stored in advance. In this case, when a ratio of a size of a reference area (logo of a product brand) with respect to an object area computed by the management unit determination unit 120 is closer to “4:1” rather than “2:1”, the management unit determination unit 120 can determine that a management unit of the product present in the object area is “500 ml (500 ml container)”. On the other hand, when a ratio of a size of a reference area (logo of a product brand) with respect to an object area computed by the management unit determination unit 120 is closer to “2:1” rather than “4:1”, the management unit determination unit 120 can determine that a management unit of the product present in the object area is “350 ml (350 ml container)”. Further, the management unit determination unit 120 may compute a theoretical value related to a ratio of a size of a reference area with respect to an object area by using external appearance feature information (e.g., a sample image acquired by photographing a product from a front side) of a product determined by the product determination unit 130. Also in this case, the management unit determination unit 120 can similarly determine a management unit, based on similarity of a ratio of a size of a reference area with respect to an object area. Then, the product determination unit 130 returns information on a management unit determined as described above, as a reply to a request from the product determination unit 130.

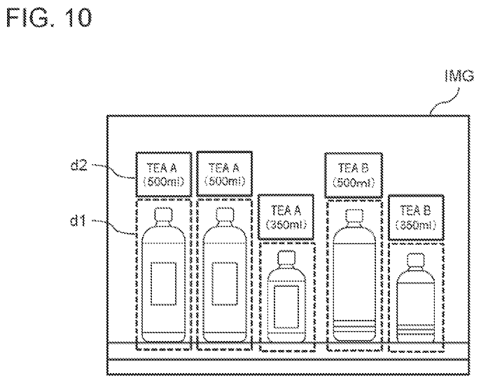

The product determination unit 130 finally determines one product from among a plurality of products being the same except for a management unit, based on a management unit determined by the management unit determination unit 120. For example, when a management unit determined by the management unit determination unit 120 is “350 ml (350 ml container)”, the product determination unit 130 determines “tea A of a 350 ml container”, as a final product determination result out of “tea A of a 350 ml container” and “tea A of a 500 ml container” determined by processing of S210. Then, the product determination unit 130 outputs information on the finally determined product. The product determination unit 130 can output, for example, information as illustrated in FIG. 10 to an output apparatus selected optionally, as a result acquired by performing the above-described processing regarding each object area to be detected from an image to be processed.

FIG. 10 is a diagram illustrating one example of information output by the product determination unit 130. FIG. 10 illustrates one example of an output screen when an image IMG acquired by photographing at least a part of a product shelf on which a plurality of products are displayed is acquired as an image to be processed. The product determination unit 130 overlaps, on the image IMG, an indication d1 indicating each object area extracted from the image IMG, and an indication d2 indicating information (e.g., a product name, a management unit, and the like) related to a product determined for each object area so as to generate data for an output screen. The product determination unit 130 transmits, to a terminal 20 used by a sales person, for example, data for an output screen generated as described above, and causes a display of the terminal 20 to display the data. A sales person can easily recognize a display state (e.g., whether each product is displayed at a correct position, or the like) on a product shelf by referring to a screen as illustrated in FIG. 10 displayed on the terminal 20.

### Modification Examples

In the above example, processing of determining a management unit is performed after processing of determining a product, but processing of determining a management unit may be performed prior to processing of determining a product. In this case, the image analysis system 1 performs processing as described below.

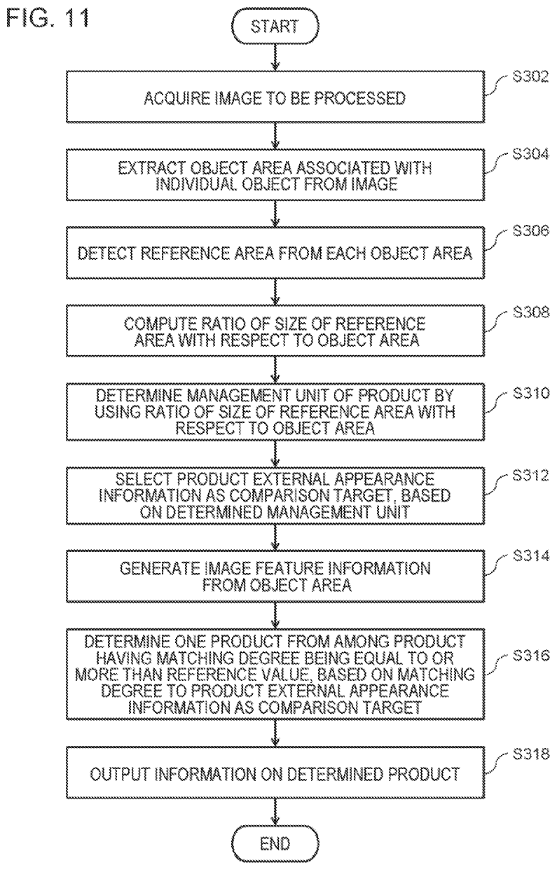

FIG. 11 is a flowchart illustrating another example of processing to be performed by the image analysis system 1 according to the second example embodiment.

Pieces of processing from S302 to S310 in FIG. 11 are similar to the pieces of processing from S102 to S110 in FIG. 3. By these pieces of processing, a management unit is determined based on a ratio of a size of a reference area with respect to an object area.

A product determination unit 130 selects, from among pieces of product external appearance information of products registered in dictionary data, product external appearance information that should be compared with image feature information acquired from an image, based on a determined management unit (S312). For example, it is assumed that an area of “a cap of a PET bottle” is detected as a reference area from a certain object area by the reference area detection unit 110, and a management unit of “350 ml” is determined by the management unit determination unit 120, based on a ratio of a size of a reference area with respect to the object area. In this case, the product determination unit 130 selects, as information that should be compared in determining a product, product external appearance information of a product in which a management unit is “350 ml”. For example, when dictionary data as illustrated in FIG. 7 are stored, the product determination unit 130 selects, as a comparison target, product external appearance information of a product in which a management unit is “350 ml”, including at least product external appearance information being associated with “product identification information:0001”, and product external appearance information associated with “product identification information: 0003”.

Then, the product determination unit 130 generates image feature information for each of the object areas extracted by processing of S304 (S314). Then, the product determination unit 130 computes, regarding image feature information of each object area generated by processing of S314, a matching degree with each of pieces of the product external appearance information selected by processing of S312, and determines a product having a matching degree being equal to or more than a reference value regarding each object area (S316). Herein, when a plurality of products having a matching degree being equal to or more than a reference value are determined, the product determination unit 130 can select one product in which a matching degree is largest, and acquire the selected one product, as a final determination result. Then, the product determination unit 130 outputs information related to the determined product (S318).

According to a present modification example, it is possible to narrow down (reduce) an amount of information to be collated, based on a management target. Thus, an advantageous effect of shortening a time for processing of determining a product is expected. Further, by narrowing down a comparison target by using a management unit, an advantageous effect of preventing erroneous recognition among products of a same type and a different size is expected.

As described above, while the example embodiments according to the present invention have been described with reference to the drawings, the present invention should not be limited and interpreted to these, and various changes, improvements, and the like can be performed based on knowledge of a person skilled in the art without departing from the gist of the present invention. Further, a plurality of constituent elements disclosed in the example embodiments can form various inventions by appropriate combination. For example, some constituent elements may be deleted from all constituent elements described in the example embodiments, or constituent elements of a different example embodiment may be combined appropriately.

Further, in a plurality of flowcharts used in the above description, a plurality of steps (pieces of processing) are described in order. However, an order of execution of steps to be performed in each example embodiment is not limited to the order of description. In each example embodiment, the illustrated order of steps can be changed within a range that does not adversely affect a content. Further, the above-described example embodiments can be combined, as far as contents do not conflict with each other.

A part or all of the above-described example embodiments may also be described as the following supplementary notes, but is not limited to the following.

1.

An image analysis system including:
a reference area detection unit that detects a reference area within a product from an image by processing the image of the product; and
a management unit determination unit that determines a management unit of the product by using a ratio of a size of the reference area with respect to an image area of the product.
   2.

The image analysis system according to supplementary note 1, further including
a product determination unit that determines, by comparing image feature information acquired from the image with product external appearance information indicating an external appearance feature of each product, a product having the external appearance feature having a matching degree, which is equal to or more than a reference, to the image feature information, in which,
when a plurality of products being a same except for a management unit are determined as a result of comparison of the image feature information with the product external appearance information,
the reference area detection unit detects the reference area from the image, and
the management unit determination unit determines the management unit of the product.
   3.

The image analysis system according to supplementary note 1, further including
a product determination unit that determines, by comparing image feature information acquired from the image with product external appearance information indicating an external appearance feature of each product, a product having the external appearance feature having a matching degree, which is equal to or more than a reference, to the image feature information, in which
the product determination unit selects the product external appearance information that should be compared with the image feature information from among the product external appearance information of each product, based on the determined management unit. 4.

The image analysis system according to any one of supplementary notes 1 to 3, in which
the reference area is defined for each product.
   5.

The image analysis system according to any one of supplementary notes 1 to 4, in which
the reference area detection unit detects, as the reference area, an area associated with at least any one of a cap portion of a product, a sealing portion of a product package, a logo of a company or a product brand, a product display mark, and an indication of special notes.
   6.

The image analysis system according to any one of supplementary notes 1 to 4, in which
the management unit determination unit determines the management unit by using a ratio of a size of the reference area with respect to the image area of the product in a height direction.
   7.

An image analysis method including,
by a computer:
detecting a reference area within a product from an image by processing the image of the product; and
determining a management unit of the product by using a ratio of a size of the reference area with respect to an image area of the product. 8.

The image analysis method according to supplementary note 7 further including,
by the computer:
determining, by comparing image feature information acquired from the image with product external appearance information indicating an external appearance feature of each product, a product having the external appearance feature having a matching degree, which is equal to or more than a reference, to the image feature information; in which
when a plurality of products being a same except for a management unit are determined as a result of comparison of the image feature information with the product external appearance information,
detecting the reference area from the image; and
determining the management unit of the product.
   9.

The image analysis method according to supplementary note 8, further including,
by the computer:
determining, by comparing image feature information acquired from the image with product external appearance information indicating an external appearance feature of each product, a product having the external appearance feature having a matching degree, which is equal to or more than a reference, to the image feature information; and
selecting the product external appearance information that should be compared with the image feature information from among the product external appearance information of each product, based on the determined management unit.
   10.

The image analysis method according to any one of supplementary notes 7 to 9, in which
the reference area is defined for each product. 11.

The image analysis method according to any one of supplementary notes 7 to 10, further including,
by the computer,
detecting, as the reference area, an area associated with at least any one of a cap portion of a product, a sealing portion of a product package, a logo of a company or a product brand, a product display mark, and an indication of special notes.
   12.

The image analysis method according to any one of supplementary notes 7 to 10, further including,
by the computer,
determining the management unit by using a ratio of a size of the reference area with respect to the image area of the product in a height direction.
   13.

A program causing a computer to function as:
a reference area detection unit that detects a reference area within a product from an image by processing the image of the product; and
a management unit determination unit that determines a management unit of the product by using a ratio of a size of the reference area with respect to an image area of the product.
   14.

The program according to supplementary note 13 causing
the computer to further function as
a product determination unit that determines, by comparing image feature information acquired from the image with product external appearance information indicating an external appearance feature of each product, a product having the external appearance feature having a matching degree, which is equal to or more than a reference, to the image feature information, in which, when a plurality of products being a same except for a management unit are determined as a result of comparison of the image feature information with the product external appearance information,
the reference area detection unit detects the reference area from the image, and
the management unit determination unit determines the management unit of the product.
   15.

The program according to supplementary note 13 causing the computer to further function as
a product determination unit that determines, by comparing image feature information acquired from the image with product external appearance information indicating an external appearance feature of each product, a product having the external appearance feature having a matching degree, which is equal to or more than a reference, to the image feature information, in which
the product determination unit selects the product external appearance information that should be compared with the image feature information from among the product external appearance information of each product, based on the determined management unit.
   16.

The program according to any one of supplementary notes 13 to 15, in which
the reference area is defined for each product.
   17.

The program according to any one of supplementary notes 13 to 16, in which
the reference area detection unit detects, as the reference area, an area associated with at least any one of a cap portion of a product, a sealing portion of a product package, a logo of a company or a product brand, a product display mark, and an indication of special notes.
   18.

The program according to any one of supplementary notes 13 to 16, in which
the management unit determination unit determines the management unit by using a ratio of a size of the reference area with respect to the image area of the product in a height direction.

### REFERENCE SINGS LIST

1 Image analysis system
110 Reference area detection unit
120 Management unit determination unit
130 Product determination unit
10 Information processing apparatus
1010 Bus
1020 Processor
1030 Memory
1040 Storage device
1050 Input/output interface
1060 Network interface
20 Terminal

What is claimed is:

1. An image analysis system comprising:
at least one memory configured to store instructions; and
at least one processor configured to execute the instructions to perform operations comprising:
detecting a reference area within a product from an image by processing the image of the product; and
determining a management unit of the product by using a ratio of a size of the reference area with respect to an image area of the product.

2. The image analysis system according to claim 1, wherein the operations further comprise:
determining, by comparing image feature information acquired from the image with product external appearance information indicating an external appearance feature of each product, a product having the external appearance feature having a matching degree, which is equal to or more than a reference, to the image feature information,
when a plurality of products being a same except for a management unit are determined as a result of comparison of the image feature information with the product external appearance information,
detecting the reference area from the image, and
determining the management unit of the product.

3. The image analysis system according to claim 1, wherein the operations further comprise
determining, by comparing image feature information acquired from the image with product external appearance information indicating an external appearance feature of each product, a product having the external appearance feature having a matching degree, which is equal to or more than a reference, to the image feature information,
selecting the product external appearance information that should be compared with the image feature information from among the product external appearance information of each product, based on the determined management unit.

4. The image analysis system according to claim 1, wherein
the reference area is defined for each product.

5. The image analysis system according to claim 1, wherein the operations further comprise
detecting, as the reference area, an area associated with at least any one of a cap portion of a product, a sealing portion of a product package, a logo of a company or a product brand, a product display mark, and an indication of special notes.

6. The image analysis system according to claim 1, wherein the operations further comprise
determining the management unit by using a ratio of a size of the reference area with respect to the image area of the product in a height direction.

7. An image analysis method comprising,
by a computer:
detecting a reference area within a product from an image by processing the image of the product; and
determining a management unit of the product by using a ratio of a size of the reference area with respect to an image area of the product.

8. A non-transitory computer-readable medium storing a program for causing a computer to perform operations comprising:
detecting a reference area within a product from an image by processing the image of the product; and
determining a management unit of the product by using a ratio of a size of the reference area with respect to an image area of the product.
